(19) United States
(12) Patent Application Publication
(10) Pub. No.: US 2011/0238194 A1
(43) Pub. Date: Sep. 29, 2011

(54) SYSTEM, METHOD AND COMPUTER PROGRAM PRODUCT FOR INTELLIGENT GROUPWISE MEDIA SELECTION

(75) Inventor: Louis B. Rosenberg, Arroyo Grande, CA (US)

(73) Assignee: Outland Research, LLC, Pismo Beach, CA (US)

(21) Appl. No.: 13/156,311

(22) Filed: Jun. 8, 2011

Related U.S. Application Data
(63) Continuation of application No. 11/676,298, filed on Feb. 18, 2007.
Application No. 11/676,298 is a continuation-in-part of application No. 11/223,368, filed on Sep. 9, 2005, now abandoned.
Application No. 11/676,298 is a continuation-in-part of application No. 11/267,079, filed on Nov. 3, 2005, now Pat. No. 7,542,816.
Application No. 11/676,298 is a continuation-in-part of application No. 11/533,037, filed on Sep. 19, 2006, now Pat. No. 7,562,117.
Application No. 11/533,037 is a continuation-in-part of application No. 11/285,534, filed on Nov. 22, 2005, now Pat. No. 7,489,979.
Application No. 11/533,037 is a continuation-in-part of application No. 11/223,368, filed on Sep. 9, 2005, now abandoned.
Application No. 11/676,298 is a continuation-in-part of application No. 11/285,534, filed on Nov. 22, 2005, now Pat. No. 7,489,979.
Application No. 11/676,298 is a continuation-in-part of application No. 11/383,197, filed on May 12, 2006, now abandoned.
(60) Provisional application No. 60/809,951, filed on May 31, 2006.
(60) Provisional application No. 60/644,417, filed on Jan. 15, 2005.
(60) Provisional application No. 60/665,291, filed on Mar. 26, 2005.
(60) Provisional application No. 60/648,197, filed on Jan. 27, 2005.
(60) Provisional application No. 60/665,291, filed on Mar. 26, 2005.
(60) Provisional application No. 60/651,771, filed on Feb. 9, 2005.
(60) Provisional application No. 60/648,197, filed on Jan. 27, 2005.
(60) Provisional application No. 60/644,417, filed on Jan. 15, 2005.
(60) Provisional application No. 60/665,291, filed on Mar. 26, 2005.
(60) Provisional application No. 60/651,771, filed on Feb. 9, 2005.
(60) Provisional application No. 60/648,197, filed on Jan. 27, 2005.
(60) Provisional application No. 60/723,021, filed on Oct. 1, 2005.

(51) Int. Cl. G06F 17/00

(52) U.S. Cl. 700/94

(57) ABSTRACT

A system, method, and computer program product is provided which enables a media player to automatically select and play one or more media files from among a plurality of available media files to a group of users such that each of the members of the group are likely to be partial towards the automatically selected media file. In an exemplary embodiment, the media player may be configured to automatically select the media file from the plurality of available media files in dependence on media exposure history data and/or media taste preference data of associated with each of the users in the group of users. In another exemplary embodiment, the media exposure history data and/or the media taste preference data associated with each user may be retrievably stored in a portable information device on the person of the user.

### CROSS-REFERENCE TO RELATED APPLICATIONS

This application is a continuation of U.S. application Ser. No. 11/676,298, filed Feb. 18, 2007, where Ser. No. 11/676,298 claims priority from Ser. No. 60/809,951 filed on May 31, 2006; Ser. No. 11/676,298 is a continuation-in-part of U.S. application Ser. No. 11/223,368 filed on Sep. 9, 2005, which claims priority from Ser. No. 60/644,417 filed on Jan. 15, 2005; Ser. No. 11/676,298 is a continuation-in-part of U.S. application Ser. No. 11/267,079 filed on Nov. 3, 2005, now U.S. Pat. No. 7,542,816, which claiming priority from Ser. Nos. 60/665,291 filed on Mar. 26, 2005, and 60/648,197 filed on Jan. 27, 2005; Ser. No. 11/676,298 is a continuation-in-part of U.S. application Ser. No. 11/533,037 filed on Aug. 19, 2006, now U.S. Pat. No. 7,562,117, where Ser. No. 11/533,037 a continuation-in-part of Ser. No. 11/285,534 filed on Nov. 22, 2005, now U.S. Pat. No. 7,489,979, which claiming priority from Ser. Nos. 60/665,291 filed on Mar. 26, 2005, 60/651,771 filed on Feb. 9, 2005, and 60/648,197 filed on Jan. 27, 2005; Ser. No. 11/533,037 is a continuation-in-part of U.S. application Ser. No. 11/223,368 filed on Sep. 9, 2005, which claims priority from Ser. No. 60/644,417 filed on Jan. 15, 2005; and Ser. No. 11/533,037 claims priority from Ser. No. 60/720,071 filed on Sep. 23, 2005; Ser. No. 11/676,298 is a continuation-in-part of U.S. application Ser. No. 11/285,534 filed on Nov. 22, 2005, which claims priority from Ser. Nos. 60/665,291 filed on Mar. 26, 2005, 60/651,771 filed on Feb. 9, 2005, and 60/648,197 filed on Jan. 27, 2005; and Ser. No. 11/676,298 is a continuation-in-part of U.S. application Ser. No. 11/383,197 filed on May 12, 2006, which claims priority from Ser. No. 60/723,021 filed on Oct. 1, 2005; and

where this application is also a related application to PCT/US2006/004373 filed Feb. 7, 2006; wherein all of the aforementioned patents applications are hereby incorporated by reference in their entirety as if fully set forth herein.

### RELEVANT INVENTIVE FIELD

The present inventive embodiments relates generally to media players and more specifically to media players configured to automatically and intelligently incorporate media exposure history and media taste preferences of a plurality of users into the selection and playing of media files.

### BACKGROUND

Electronic media players have become popular personal entertainment devices due to their highly portable nature and interconnectivity with existing computer networks, for example the Internet. The accessibility and simplicity in downloading music and other electronic media continues to fuel the popularity of these devices as is exemplified by Apple Computer, Inc.'s highly successful iPod™ media player. Other manufacturers have competing media players offering various functionalities and file playing compatibilities in an effort to differentiate their products in the marketplace.

As discussed in Apple Computer, Inc., patent application, US 2004/0224638 A1, Ser. No. 10/423,490 to Fadell, et al., which is herein incorporated by reference in its entirety; an increasing number of consumer products are incorporating circuitry to play musical media files and other electronic media. For example, many electronic devices such as cellular telephones and personal digital assistants (PDAs) include the ability to play electronic musical media in many of the most commonly available file formats including MP3, AVI, WAV, MPG, QT, WMA, AIFF, AU, RAM, RA, MOV, MIDI, etc.

In the relevant art, media players lack the ability to automatically select media files for play to a group of users such that the selected media file is likely to be preferred by a substantial majority of the members of the group. More specifically, the present art lacks the ability to consider the media exposure history and/or the media tastes of each member of a group of individual users who are currently residing within listening (and/or viewing) proximity of the media player so as to automatically select media files for play that are likely to be preferred by the group. For example, a media player operative to automatically select songs for play to a group of people (i.e. users) within a restaurant, bar, elevator, office, car, home, club, or other physical location where groups of people congregate, lack the ability to automatically select media files with consideration of the media exposure history of a plurality of users currently residing within that location. As a result, the media player may automatically select a media file for play that some of the users within the location have very recently experienced. Analogously, a media player operative to automatically select songs for play to a group of people within a physical particular location, lack the ability to automatically select media files with consideration of the media tastes of a plurality of users within that location.

As a result, the media player may select a media file that some of the users may dislike. What is therefore desired is a predictive mechanism that automatically performs media file selection and playing for groups of users, automatically and intelligently considers the media exposure history of a plurality of such users and/or automatically and intelligently considers the media tastes of a plurality of such users. In addition, an automated mechanism by which a user may store upon his person and regularly update a datastore that represents his or her media exposure history and/or media tastes such that the datastore may be automatically accessed by a media player when the user resides within proximity of the media player output. Unless otherwise indicated herein, the approaches described in this section are not prior art to the claims in this application and are not admitted to be prior art by inclusion in this section.

### SUMMARY

A system, method, and computer program product is provided which addresses the desired featured of lacking in the relevant art. Various exemplary embodiments are described which enables a media player to automatically select and play one or more media files from among a plurality of available media files to a group of users in proximity to the media player such that each of the users are favorably disposed to experience the automatically selected and played media file. In an exemplary embodiment, an intelligent groupwise media selection system is provided. The intelligent groupwise media selection system comprises a plurality of personal information devices, each personal information device being associated with an individual user and having retrievably stored therein a data file representing the individual user's media taste preferences.

A media player is provided which includes a processor, a communications transceiver operatively coupled to the processor and in processing communications with each of the plurality of personal information devices, a memory coupled to the processor, a plurality of media files retrievably stored in the memory and a groupwise selection program operatively loaded into the memory. The groupwise selection program includes having instructions executable by the processor to interrogate the personal information devices to receive a representation of the data files, determine a composite of the media taste preferences of the individual users from the received data file representations, select a media file from the plurality of media files in dependence on the determined composite media taste preferences and play the selected media file to at least a portion of the individual users.

In an exemplary embodiment, the media file is selected in dependence on an assessed level of correspondence between the composite media taste preferences and a characteristic associated with the selected media file.

In another exemplary embodiment, the groupwise selection program further includes instructions executable by the processor to select a plurality of media tiles in dependence on the composite media taste preferences of the individual users and arrange the plurality of selected media files in a playlist for play.

In another exemplary embodiment, the data representing the media taste preferences further comprises a user rating with respect to a musical characteristic.

In another exemplary embodiment, the musical characteristic consists essentially of a musical genre, a musical artist, a musical album, a musical composition and any combination thereof.

In another exemplary embodiment, the data files further comprises data representing media exposure history; the media exposure history data including event data associated with a number of times an individual user experiences a particular media file over a determined period of time.

In another exemplary embodiment, the groupwise selection program further comprises instructions executable by the processor to calculate and apply a weighting factor to the composite media taste preferences in dependence on the assessed level of correspondence.

In another exemplary embodiment, the groupwise selection program selects a media file from among the plurality of media files using a weighted random selection process that applies the weighting factor.

In another exemplary embodiment, the personal information device is selected from the group consisting essentially of an RFID chip, a smartcard chip, a cellular telephone, a portable media player, a personal digital assistant and a third party server.

In yet another exemplary embodiment, at least one of the personal information devices further comprises a global positioning system receiver for determining a current geospatial location of the user of that personal information device, the current geospatial location being used to determine if that user is within a certain proximity of the media player.

In still another exemplary embodiment, the data representing the geospatial location of at least one personal information device is transmitted to a third party server for determination of whether the data representing the media taste preferences of a user is to be conveyed to the media player by the third party server.

In another exemplary embodiment, data representing a unique ID associated with a particular user is transmitted to a third party server that accesses media taste preference data for that user and provides a representation of the media taste preference data to the media for a groupwise selection process.

### BRIEF DESCRIPTION OF DRAWINGS

The features and advantages of the various inventive embodiments will become apparent from the following detailed description when considered in conjunction with the accompanying drawings. Where possible, the same reference numerals and characters are used to denote like features, elements, components or portions of the various embodiments. It is intended that changes and modifications can be made to the various described embodiments without departing from the true scope and spirit of the inventive embodiments as generally defined by the claims.

FIG. 1—depicts a generalized block diagram of a media player.

FIG. 1A—depicts a generalized block diagram of a portable information device.

FIG. 2 provides a generalized communications arrangement between a plurality of personal information devices, a media player and/or a third party server.

FIG. 3—depicts an exemplary pseudo-processing architecture of the media player.

FIG. 4—depicts a flow chart of an exemplary embodiment which performs the various functions and processes described herein.

### DETAILED DESCRIPTION

The various exemplary embodiments provides a system, method and computer program product which automatically selects and plays a media file on a media player for a group of users who are within listening (and/or viewing) proximity of the media player such that the selected media file(s) are likely to be favored by a majority and/or a significant portion of the users. For example, a media player may be associated with a restaurant that a group of users are dinning. The media player as described herein is configured to select and plays media files that are likely favored by a majority or optionally a significant portion of the users based on data received from personal information devices of the users. The data received by the media player may include individual user media taste preferences and/or media exposure history data which is used to perform the automated media selection process.

In an exemplary embodiment, a media play receives data representing a plurality of user's individual media taste preferences. The media preference taste data is then used to retrieve one or media files from a datastore which is likely to be perceived favorably by a majority or optionally a significant portion of the users. The media preference taste data comprises such media preference characteristics as that user's partiality towards a particular musical genre, musical artist, musical album, musical composition and any combination these characteristics. In some exemplary embodiments, the partiality is represented as a binary value indicating whether the user is partial or not partial. In other exemplary embodiments, the partiality is represented as a scaled value on a range of partialities from highly partial to highly not partial. In other exemplary embodiments, the partiality is represented as a ranking, for example indicating the ranked partiality for that user among a plurality of different musical genres, musical artists, musical albums, and/or musical compositions.

In some such exemplary embodiment, the preference characteristics for an individual user may include a listing of that user's most preferred musical artists as well as a listing of that user's most disliked musical artists.

In some such exemplary embodiment, the preference characteristics for an individual user may include a ranked ordering of that user's preference towards a plurality of musical genres. For example indicating the ranked preference from most favored to least favored among two or more of the musical genres, Pop, Classic Rock, Heavy Metal, Reggie, New Age, Alternative Rock, Jazz, Classical, Rhythm and Blues, Funk, Gospel, Latin, Christian Rock, Dance, Electronica, Hip-Hop, Punk, Acid Rock, Grunge, New Wave, Folk, Big Band, Soul, Show Tunes, Calypso, Celtic, Bluegrass, and Disco.

In some such exemplary embodiment, the preference characteristics for an individual user may include a ranked ordering of that user's preference towards a plurality of musical periods of time. For example indicating the ranked preference from most favored to least favored among two or more of music from the 1950's, 1960's, 1970's, 1980, 1990's, and 2000's. In some exemplary embodiments, a user may specify preferences across multiple categorizations, for example indicating their preferences by both musical genre and period of time during which the music was released.

In an exemplary embodiment, data representing media exposure history of the users may be used to further refine the media file selection process. The media exposure history data comprises a chronological log of when and how often each user has listened to, viewed and/or otherwise experienced a particular media file.

Thus, through the access and use of the media taste preference data and/or the media exposure history data a media player may be configured to automatically select a media file from a plurality of available media files for play to a group of users such that the selected media file has not been previously experienced recently by each of the individual users (or by a significant portion thereof) within a certain predetermined time period; and/or has not been experienced more than a certain number of times within a determined time period; and/or favorably matches one or more personal media taste characteristics of a majority and/or a significant portion of the users.

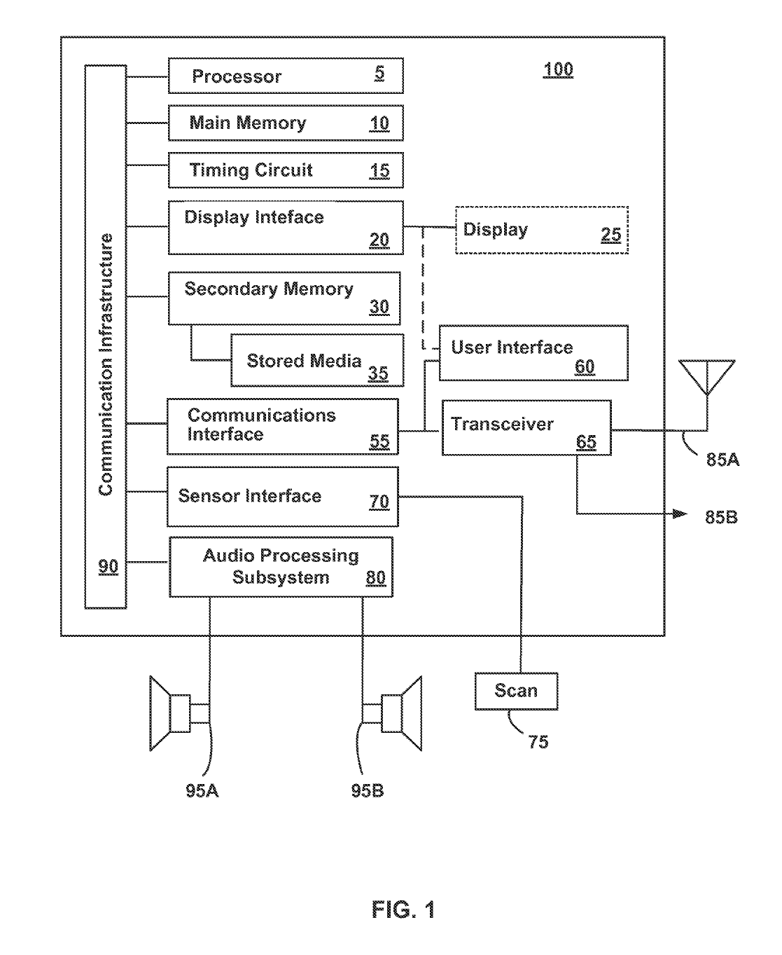

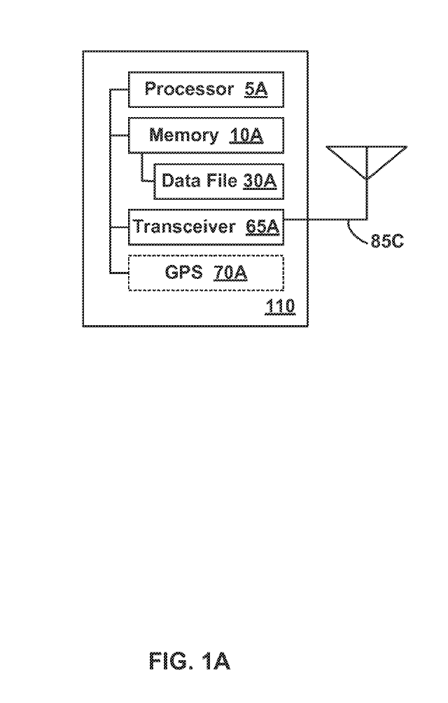

Referring to FIG. 1, a generalized block diagram of a media player 100 is depicted. The media player 100 includes a communications infrastructure 90 used to transfer data, memory addresses where data files are to be found and control signals among the various components and subsystems associated with the media player 100.

A processor 5 is provided to interpret and execute logical instructions stored in the main memory 10. The main memory 10 is the primary general purpose storage area for instructions and data to be processed by the central processor 5. The term “main memory” 10 is used in its broadest sense and includes RAM, EEPROM and ROM.

A timing circuit 15 is provided to coordinate activities within the media player in near real time. The central processor 5, main memory 10 and timing circuit 15 are coupled to the communications infrastructure 90.

A display interface 20 is provided to drive a display 25 associated with the media player 100. The display interface 20 is electrically coupled to the communications infrastructure 90 and provides signals to the display 25 for visually outputting both graphical displays and alphanumeric characters. The display interface 20 may include a dedicated graphics processor and memory to support the displaying of graphics intensive media. The display 25 may be of any type (e.g., cathode ray tube, gas plasma) but in most circumstances will usually be a solid state device such as liquid crystal display.

A secondary memory 30 is provided which houses retrievable storage units such as a hard disk drive and/or flash memory. In an exemplary embodiment; the secondary memory 30 has retrievably stored therein a plurality of media files 35. The secondary memory 30 is coupled to the communications infrastructure 90 to allow access controlled by the processor 5.

A communications interface 55 subsystem is provided which allows for standardized electrical connection of peripheral devices to the communications infrastructure 90; including, serial, parallel, USB, and Firewire™ connectivity. For example, a user interface 60 and a transceiver 65 are electrically coupled to the communications infrastructure 90 via the communications interface 55. For purposes of this specification, the term user interface 60 includes the hardware and operating software by which a user interacts with the media player 100 and the means by which the media player conveys information to the user and may include the display interface 20 and display 25.

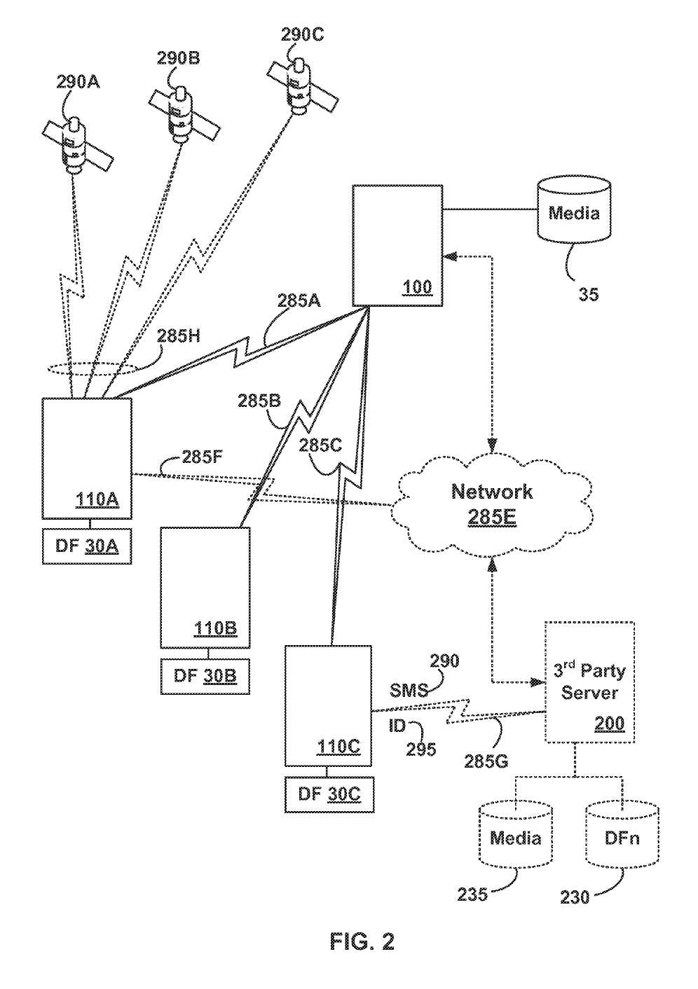

The transceiver 65 facilitates the remote exchange of data and synchronizing signals between the media player 100 and other devices in processing communications 85A,B with the media player 100. The other devices includes in various exemplary embodiments, a plurality of personal information devices 110 (FIG. 1A), and a third party server 200 (FIG. 2).

Communications with the other devices may be established using the transceiver 65. The transceiver 65 is envisioned to be of a radio frequency type normally associated with computer networks for example, wireless computer networks based on BlueTooth™ or the various IEEE standards 802.11x, where x denotes the various present and evolving wireless computing standards, for example WiMax 802.16 and WRANG 802.22. Alternately, digital cellular communications formats compatible with for example GSM, 3G, CDMA, TDMA and evolving cellular communications standards. For example, in some exemplary embodiments, the communication format includes of SMS messaging. Both peer-to-peer (PPP) and client-server models are envisioned for implementation of various inventive embodiments. In a third alternative exemplary embodiment, the transceiver 65 may include hybrids of computer communications standards, cellular standards and evolving satellite radio standards. Both wireless 85A and wired 85B communications may be provided concurrently.

The user interface 60 employed on the media play 100 may include a pointing device (not shown) such as a mouse, thumbwheel or track ball, an optional touch screen (not shown); one or more push-button switches (not shown), one or more sliding or circular potentiometer controls (not shown) and one or more other type switches (not shown.) The user interface 60 provides interrupt signals to the processor 5 that may be used to interpret user interactions with the media player 100 and may be used in conjunction with the display interface 20 and display 25. One skilled in the art will appreciate that the user interface devices which are not shown are well known and understood.

A sensor interface 70 is provided which allows one or more sensors 75 to be operatively coupled to the communications infrastructure 90. The sensor interface 70 may monitor interactions with the user interface 60. The sensor interface may also monitor interactions with and/or detections of ambient signals and/or conditions. For example, in some exemplary embodiments, the sensor interface 70 may be coupled to a radio frequency identification (RFID) scanner 75. An interrupt circuit may be incorporated into the hardware supporting the communications infrastructure 90, sensor interface 70, user interface 60, and/or audio processing subsystem 80.

A wide range of real time and near real time sensor types are envisioned to be connectable to the media player 100; examples of which includes meteorological sensors. physiological sensors, RFID chip and contactless smartcard scanners, navigational sensors, geo-spatial sensors, motion sensors, inclination sensors, environmental sensors, and a combination thereof. Examples of such sensors are disclosed in co-pending patent application Ser. No. 11/267,079 filed on Nov. 3, 2005 and entitled “System, Method and Computer Program Product for Automatically Selecting, Suggesting and Playing Music Media Files,” by the present inventor. The sensors 75A, 75B, 75C, 75D, 75E provide their data to the processor 5 via the sensor interface 70 coupled to the communications infrastructure 90. Lastly, an audio processing subsystem 80 is provided and electrically coupled to the communications infrastructure 90. The audio processing subsystem includes one or more loudspeakers 95A,B for outputting playing media files to users in proximity to the media player 100.

The audio processing subsystem 80 provides for the playback and outputting of digital media, for example, multi or multimedia encoded in any of the exemplary formats MP3, AVI, WAV, MPG, QT, WMA, AIFF, AU, RAM, RA, MOV, MIDI, etc. As referred to in this specification, “media” refers to video, audio, streaming and any combination thereof.

In addition, the audio processing subsystem 80 is envisioned to optionally include features such as graphic equalization, volume, balance, fading, base and treble controls, surround sound emulation, and noise reduction. One skilled in the art will appreciate that the above cited list of file formats is not intended to be all inclusive.

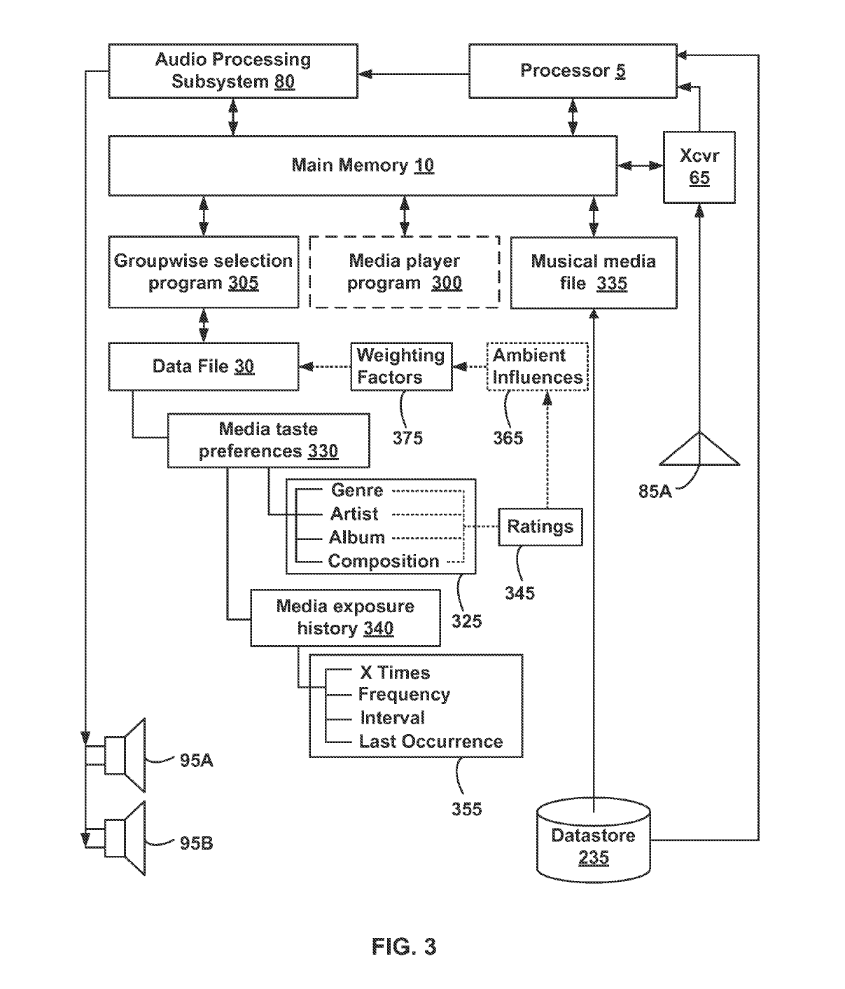

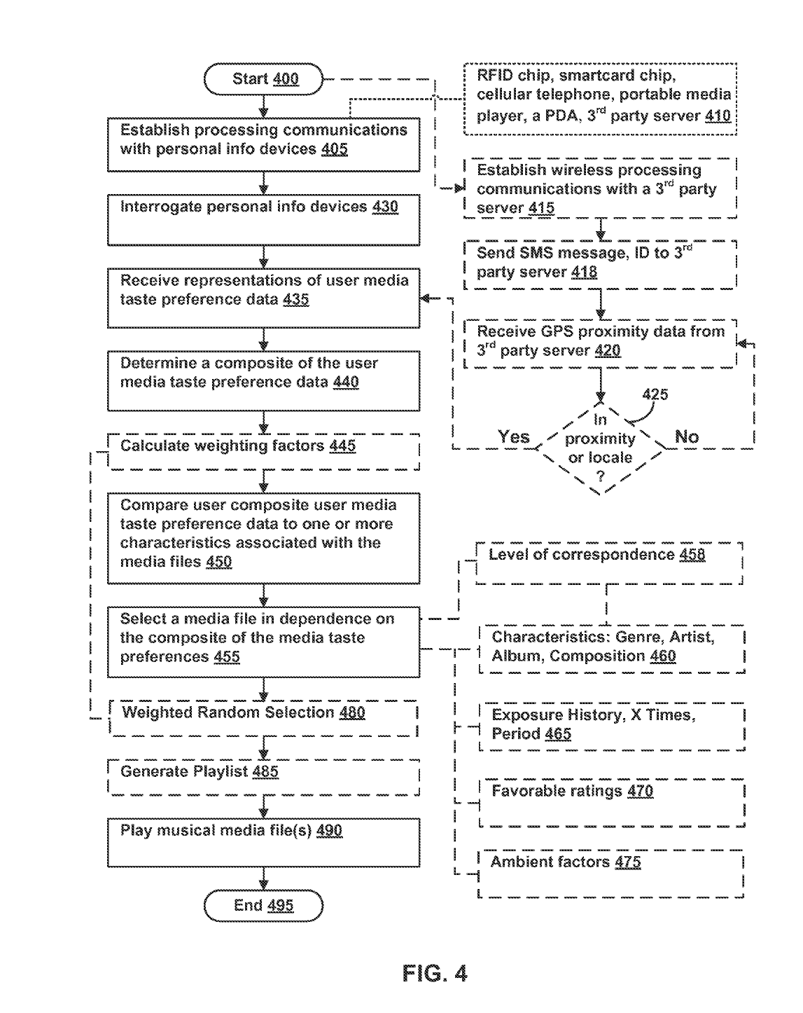

The media player 100 includes an operating system, the necessary hardware and software drivers necessary to fully utilize the devices coupled to the communications infrastructure 90, media playback and recording applications, data access routines for accessing personal data from each of a plurality of portable information devices within certain proximity, and at least one groupwise selection program 305 (FIG. 3) operatively loaded into the main memory 10. The media player 100 may also include data access routines for accessing personal data from a third party server 200 (FIG. 2), the personal data being relationally associated with an ID value or other identification value received from and/or associated with a portable information device within certain proximity. The processor 5 is programmed to execute instructions of the groupwise selection program 305 as provided for in FIG. 4. Where necessary, computer programs, algorithms and routines, subroutines, dynamically linked libraries and related data components may be programmed in a high level language computing language, for example Java (TM) C++, C#, CORBA or Visual Basic™.

For purposes of this specification, the term “program” is intended to be interpreted in its broadest sense to include all instructions executable by the processor 5 whether embodied in hardware or software. References to the various programs may be made in both singular and plural form. No limitation is intended by such grammatical usage as one skilled in the art will appreciate that multiple programs, objects, subprograms routines, algorithms, applets, contexts, etc. may be implemented programmatically to implement the various inventive embodiments.

Referring to FIG. 1A, an exemplary embodiment of a personal information device 110 is depicted. The personal information device 110 includes a processor 5A, a memory 10A coupled to the processor 5 and a transceiver 65A coupled to the processor 5A. The memory 10A includes an operatively stored data file 30A representing personal information. In an exemplary embodiment, the personal information includes an associated user's media taste preferences. In another exemplary embodiment, the personal information further includes media exposure history. In another exemplary embodiment, the personal information includes a unique user ID or other coded identifier. The personal information device 110 may be provided in a variety of arrangements including a cellular telephone, personal digital assistant (PDA), portable media player or as passive transponding chip card arrangement. For example, a contactless smartcard chip, GSM chip or RFID chip. For purposes of this specification, no distinction will be made for a smartcard chip and a GSM chip. Where a smartcard chip is referenced, a GSM chip should be assumed as well. In certain exemplary embodiments, the personal information device 110 may include a user interface for enabling user input and interaction.

One skilled in the art will appreciate that the user interface devices which are not shown are well known and understood.

The personal information may be encoded in the memory 10A of the personal information device 110 by the user connecting the device to a personal computer or laptop and downloading the user's media taste preferences. Alternately, when using any of the non-passive devices, the user's media taste preferences may be determined heuristically by an application and accumulated over a period of time.

In another exemplary embodiment, the personal information is encoded by a third party provider and sent by physical mail to the user. This exemplary embodiment may be appropriate for simple RFID chip type devices. In another exemplary embodiment, personal information may be updated by an external computer and/or media player through a wireless communication connection using Bluetooth or other wireless communications protocol. For example the media exposure history data for a user may be updated in response to a signal received form an external computer and/or media player indicating that a particular media file is playing and/or has just completed play in the listening vicinity of the user.

The processor 5 is programmed to access the stored data file 30A and transmit the personal information to either a media player 100 or third party server 200 in response to an interrogation signal received from either source via the transceiver 65A. The transceiver 65A may be configured as a transponder which is powered by an incoming RF signal provided by an RFID scanner 75 or as a true wireless device compatible with the transceiver 65 of the media player 100 or third party server 200. In another exemplary embodiment, the portable information device 110 includes a UPS receiver 70A coupled to the processor 5A and transceiver 65A. In this exemplary embodiment, GPS position data is relayed to a third party server 200. The GPS position data is used to signal the media player 100 that one or more personal information devices 110 are within a predetermined proximity or locale as is described in the discussion accompanying FIG. 2 below.

In some exemplary embodiments, the processor 5 may be configured to access the stored data file 30A and transmit the personal information to either,a media player 100 or third party server 200 in response to input from its user. For example, the user may engage a button, touch screen, or other user interface element of a personal information device 110 to actively cause a representation of at least the portion of data file 30A to be transmitted to the media player 100 or third party server 200. In some exemplary embodiments, the representation of the at least a portion of data file 30A is transmitted to media player 100 via third party server 200. In one exemplary embodiment, the user causes the personal information device 110 to send an SMS message and/or other electronic message to the media player 100 and/or the third party server 200, the electronic messaging indicating that a representation of a least a portion of the user's personal information is to be used by the groupwise selection program 305.

In one such exemplary embodiment, at least a portion of the user's personal information is transmitted in the electronic message for example including the user's media taste preferences. In another such exemplary embodiment, only a user ID value is transmitted in the electronic message, the user's media taste preferences being accessed in relation to the user ID value from a datastore 230 accessible to the third party server 200.

FIG. 2 provides a generalized communications arrangement between a plurality of personal information devices 110A,B,C, a media player 100 and/or a third party server 200. In an exemplary embodiment a personal information device 110A is in processing communications 285A with the media player 100. In an exemplary embodiment, the media player 100 becomes alerted to the presence of the personal information device 110A when the transceiver 65A of the personal information device 110A performs a handshake transaction which identifies the personal identification device 110A to the to media player 100. The identification of each personal information device 110A,B,C may be determined by each device's MAC number or other unique identifier for example, a digital certificate or serial number.

In this exemplary embodiment, each of the portable information devices 110A sends data representing its associated user's personal information retrieved from each device's data file 30A,B,C over a wireless connection 285A,B,C to the media player 100 for use by the groupwise selection program 305. This arrangement results in the playing of media file 35 which corresponds to what a majority or a significant portion of the users are likely to be partial to.

In another exemplary embodiment the each portable information device 110A,B,C is equipped with a GPS receiver 70A. In an exemplary embodiment, the GPS position data 290A,B,C from each portable information device 110A,B,C is sent over a wireless connection 285F to a third party server 200. The GPS data 290A,B,C may be sent directly 285G to the third party server 200 or sent via a wireless network 285E. The third party server 200 determines if one or more of the portable information devices 110A,B,C are within a predetermined proximity or area. The predetermined proximity or area being sufficiently close to the media player 100 to experience a media file 35 when played. If one or more of the portable information devices 110A,B,C are within a predetermined proximity or area, the third party server 200 signals the media player 100 or otherwise takes appropriate action to ensure that at least a portion of the personal information associated with the one or more portable information devices 110A,B,C is used in the groupwise media selection process that selects media for media player 100.

In some such exemplary embodiments, the third party server 200 may be configured to service a plurality of media players 100, each of the plurality of media players 100 independently playing different music for a different physical location. For example, the third party server 200 may be configured to service a plurality of different restaurants, bars, health clubs, and coffee houses, each having at least one separate media player 100 playing separate music for a separate physical location.

In such exemplary embodiments, the third party server 200 maintains in accessible memory a plurality of predetermined proximities and/or areas that are each relationally associated with a particular media player 100, indexed by a unique ID value to or other identifier for that media player 100. The third party server 200 receives GPS location data from a plurality of portable information devices 110A,B,C of a plurality of users, determines if the user is located within any one of the plurality of predetermined proximities and/or areas, and if so determines which media player 100 that location and/or area corresponds to. The third party server 200 then takes action to ensure that at least a portion of the personal information associated with that user is used in a groupwise selection process associated with that media player 100.

In an alternate exemplary embodiment, the user of each portable information device may cause his or her portable information device 110A,B,C to send an electronic message to the third party server 200 indicating affirmatively that the user is in proximity of a media player 100 and desires to have at least a portion of that user's personal information used in the groupwise media selection process that selects media for play upon that media player. Because the third party server may be configured to perform such functions for a plurality of separate media player 100's, each playing separate music to a separate physical location, this exemplary embodiment may require that the electronic message sent from the portable information device 110 to the third party server 200 indicates by unique ID code, which physical location (and/or associated media player) the user wishes his or her personal information to be used in the groupwise media selection process for.

For example, the user may send an short message service (SMS) message 290 to the third party server that includes a unique code associated with a particular restaurant, bar, club, or coffee house, thereby indicating to the third party server 200 that the user wishes to have at least a portion of his or her personal information used in the groupwise media selection process for the media player associated with that particular physical establishment. The third party server 200 then takes action to ensure that at least a portion of the personal information associated with that user is used in a groupwise selection process associated with that media player 100. This arrangement enables, for example, a user to enter a physical establishment such as a restaurant or bar or coffee house, send a quick SMS text message 290 to the third party server 200 identifying the establishment, and thereby have his or her personal tastes and/or exposure history used in combination with other similar users in the groupwise media selection of media for that physical establishment.

In certain exemplary embodiments a user is charged a fee for sending such an SMS text message 290 or other electronic message to the third party server, enabling a pay for participation service in which a user's personal tastes and/or exposure history are used in the groupwise media selection process in exchange for said fee. In one Is exemplary embodiment the user's personal tastes and/or exposure history are used in the groupwise media selection process for a certain period of time following the receipt of the SMS text message 290 or other electronic message, for example one hour, in exchange for said fee. In some such embodiments the fee is added to the phone bill of a user. In one exemplary embodiment a user is charged a fee, for example $0.25, in exchange for having his or her personal tastes and/or exposure history used in the groupwise media selection process associated with the particular physical establishment for the particular period of time.

In an exemplary embodiment, the third party server 200 receives each portable information device's personal information from the data files 30A,B,C and sends a representation of the received personal information to the media player 100 over the network 285E. In an exemplary embodiment, the third party server may determine a composite of the personal information and send the composite over the network 285E to the media player 100.

In certain exemplary embodiments, the third party server 200 may perform some or all of the functions of the groupwise media selection program 305. In this way the third party server 200 may determine one or more media files 235 which correspond to what the majority or a significant portion) of the individual users are likely to be partial to at the present time. The third party server 200 then sends an indication of the determined media files 235 to the media player 100 to be played. The sent indication may be an identifying reference enabling the third party player 100 to locally access and play the selected media file. The sent indication may be the content of the media file 235 for play by the media player 100. In this way the third party server 200 and media player 100 work cooperatively to perform the groupwise media selection and playing functions for users who are physically local to the media player 100.

In some of the above exemplary embodiments that employ a third party server 200, the personal information for a particular user may be sent as an electronic message from that user's personal information device 110 to the third party server 200 for processing. In other exemplary embodiments, the third party server maintains a datastore of personal information 230 associated with each of the portable information devices 110A,B,C (and/or its user.) In such exemplary embodiments, the third party server 200 identifies the corresponding user of each portable information device based on a unique user ID 295 that is conveyed electronically and/or other unique communications handshake that is performed when the portable information devices 110A,B,C wirelessly connect either to the server 200 or the network 285E coupled to the server 200.

As before, the identification of each personal information device 110A,B,C may be determined by each device's MAC number or other unique identifier for example, a digital certificate or serial number. In certain exemplary embodiments, the users establish accounts with the third party server 200 and are assigned a unique ID 295. In other exemplary embodiments, the unique ID 295 may be the user's phone number or other communication address. In various exemplary embodiments, the third party server 200 may perform some or all of the processing necessary to determine a composite of the user taste preferences and predict which of a plurality of media files, stored in datastore locally 235 or a datastore 35 coupled to the media player 100, would likely be appreciated by a majority or significant portion of the users who are then currently local to that particular media player.

Because the composition of users who are local to a particular media player 100 (or believed to be local to a particular media player) at any given time is continually changing as users enter and leave proximity of the media player, the media player 100 and/or third party server 200 are also configured to cease using the personal information associated with particular personal information devices 110A,B,C (and/or particular users) when it is determined that the user is no longer within proximity of the media player 100 and/or after more than a certain amount of time has elapsed since a message was received affirmatively indicating that the user is within proximity of the media player.

For example, in some exemplary embodiments that user RFID messaging, GPS locative messaging, and/or other proximity based detection and/or messaging, a user's personal information is ceased from being used in a groupwise media selection process for a particular media player 100 when the locative information no longer indicates that the user is within proximity of that media player and/or more than a certain amount of time has elapsed since it was affirmatively determined that the user is within proximity of that media player 100. Similarly, for exemplary embodiments that enable a user to IS explicitly send a message, for example an SMS message 290, indicating that the user's personal information should be used in the groupwise media selection for a particular media player, that user's personal information is ceased from being used in the groupwise media selection process for that media player 100 when either a message is received explicitly indicating that the user's personal information should no longer be used in the groupwise media selection for a particular media player and/or more than a certain amount of time has elapsed since the initial message was received.

In certain exemplary embodiments, the certain amount of time is one hour. Thus a user may enter an establishment, send a message to the third party server 200 as described previously, and have his or her personal information used in the groupwise media selection process for that establishment for a period of one hour following the transmission of the message.

Finally, a hybrid exemplary embodiment may be employed in which the media player 100 interrogates a plurality of personal information devices 110 that are within certain proximity, accesses a unique ID value 295 associated with each user (or each personal information device), and transmits the unique ID values 295 to the third party server. The third party server 200 then accesses personal information for each user by referencing data store 230 with the unique ID values 295. The third party server 200 then performs, alone or in combination with the media player 100, a groupwise media selection process using a representation of the personal information for each of the plurality of users. The media player then plays the selected song to the users who are within listening proximity.

Referring FIG. 3, an exemplary pseudo-processing architecture of the media player 100 is depicted. It should be noted that the functions described here with respect to the media player 100, in some exemplary embodiments, may be shared with and/or performed by third party server 200. The media player 100 executes a groupwise to selection program 305 to automatically select and play a media file from a plurality of available media files that are stored in datastore 235. In an exemplary embodiment, the selected media file is intelligently selected such that it is likely to be favored by a plurality of users who are currently within listening (and/or viewing) proximity of the media player 100.

In an exemplary embodiment, the media player 100 receives data 30 representing one or more individual user's media taste preferences 330, for example over a wireless connection 85A from one or more personal information devices 110A,B,C in communications with the transceiver 65. The processor 5 directs the incoming individual user's media taste preferences into the memory 10 for processing by a Groupwise selection program 305.

The Groupwise selection program 305 determines from the received data 30 each of the user's media taste preferences 330 with respect to one or more characteristics 335 associated with the media files stored in the datastore 235. The characteristics 335 include genre, artist, album, composition, and time period of release. In an exemplary embodiment, the received data 30 may also include media exposure history 340.

The media exposure history 340 includes a log of chronological exposure information 335 which includes, for example, the time of last play, frequency of play, and/or number of plays over a previous time interval and the last play occurrence of one or more media files.

Each of the characteristics 335 and/or the chronological information 355 may be separated provided with ratings 345. For example, a user may provide a rating 345 using a standard scale of 1-10 which is used to determine a user's preference for a particular media file, particular media genre, particular Media album, particular media artist, and/or particular time period of media release. As described previously, ranking values may also or alternatively be used.

An exemplary data file 30 may have formats such as provided in Tables 1, 2 and 2 below. The exemplary data file formats are indicative of a database, however, a flat file format would work as well.

TABLE 1
Exemplary User Ratings Based on Genre

| | | Rating |
|---|---|---|
| User_001 | Rock | 10 |
| Genre | Jazz | 7 |
| | Rap | 2 |
| | Blues | 6 |
| | Country | 3 |
| User_002 | Rock | 6 |
| Genre | Jazz | 4 |
| | Rap | 0 |
| | Blues | 6 |
| | Country | 3 |
| User_003 | Rock | 3 |
| Genre | Jazz | 5 |
| | Rap | 6 |
| | Blues | 2 |
| | Country | 9 |

Table 1 provides a high level data arrangement where a user enters his or her preferences for predetermined genre categories. This arrangement allows a relatively rapid determination of individual media taste preferences to arrive at a composite media taste preference. In certain exemplary embodiments, unrated characteristics are automatically assigned a nominal value, for example a neutral value of 5 on a scale of 0 to 10.

TABLE 2
Exemplary User Ratings Based on Additional Characteristics

| | | Artist | Album | Composition |
|---|---|---|---|---|
| User_001 | File_001 | Heart | Greatest Hits | Magic Man |
| | Rating | 10 | 8 | 7 |
| | File_002 | Eagles | Greatest Hits | Hotel California |
| | Rating | 8 | 8 | 10 |
| | File_003 | Beastie Boys | License To Ill | Fight For Your |
| | | | | Right |
| | Rating | 6 | 3 | 5 |
| User_002 | File_001 | Heart | Greatest Hits | Magic Man |
| | Rating | 5 | 7 | 7 |
| | File_002 | Eagles | Greatest Hits | Hotel California |
| | Rating | 7 | 7 | 8 |
| | File_003 | Beastie Boys | License To Ill | Fight For Your |
| | | | | Right |
| | Rating | 6 | 6 | 8 |
| User_003 | File_001 | Heart | Greatest Hits | Magic Man |
| | Rating | 2 | 1 | 3 |
| | File_002 | Eagles | Greatest Hits | Hotel California |
| | Rating | 5 | 6 | 9 |
| | File_003 | Beastie Boys | License To Ill | Fight For Your |
| | | | | Right |
| | Rating | 10 | 9 | 10 |

Table 2 provides a more detailed data arrangement where each user enters his or her preferences for an actually experienced media file. This arrangement allows a more accurate assessment of individual media taste preferences to arrive at a composite media taste preference. A data format of this type is particularly useful when all users have experienced the same media files and provided ratings thereto.

TABLE 3
Exemplary User Ratings Based on Chronology

| | | | Freq. | Interval | Last |
|---|---|---|---|---|---|
| | | No. Times | (mo) | (days) | (date) |
| User_001 | File_001 | 12 | 2 | 15 | 2454147 |
| | File_002 | 3 | 4 | 6 | 2454108 |
| | File_003 | 1 | 1 | 1 | 2454144 |
| User_002 | File_001 | 2 | 2 | 30 | 2454113 |
| | File_002 | 5 | 5 | 10 | 2454084 |
| | File_003 | 4 | 1 | 45 | 2454023 |
| User_003 | File_001 | 2 | 1 | 12 | 2453840 |
| | File_002 | 1 | 1 | 0 | 2454099 |
| | File_003 | 9 | 9 | 3 | 2454146 |

Table 3 provides detailed chronological data obtained for each media file experienced by the users of Table 2. The data includes the number of times a media file was experienced, how often a particular media file was experienced over the course of a month, an average interval of experiencing the particular media file and the last date in which the particular media file was experienced. The chronological data chosen in this exemplary Table 3 are arbitrarily chosen. The date information is shown in a Julian date format.

Based on the personal information obtained from each of the portable information devices 110A,B,C (and/or accessed from a third party server 200 with reference to a unique ID value accessed from the portable information devices 110A,B,C) a composite of the individual media taste preferences can be determined using simple weighting of the various results. For example, using the highest media taste preference information from Table 1 would provide composite media taste preferences of 6.3 for Rock, 5.3 for Jazz, 2.7 for Rap, 4.7 for Blues, 5.0 for Country. As such Rock would be favored for selection-over all other categories. In an exemplary embodiment, a playlist could be generated which included 6 Rock media files, 5 Jazz media files, 3 Rap media files, 5 Blues media files and 5 Country media files. The determined weighting factors 375 may then be used to select one or more media files from the datastore.

In certain exemplary embodiments, only media files associated with genres that have a composite media taste preference values exceeding a certain threshold are selected. For example, if a composite media taste threshold value of 5.0 was used, only Rock and Jazz media files would be selected for the group of users represented by the example data. In addition, the proportion of Rock selections versus Jazz selections may be controlled such that it approximately reflects the relative composite rating values. Analogously, the more specific media taste preference information from Table 2 could be used to determine the most favorable artist based on the numeric ratings provided by each of the users. In an exemplary embodiment, the most favorable artist appears to be The Beastic Boys 7.3, followed by the Eagles 6.7 and Heart 5.7. In an exemplary embodiment, the most favorable album would be the Eagles greatest hits 7.0 followed by License to III 6.0 and Hearts greatest hits 5.3. In another exemplary embodiment selecting the most favorable composition, Hotel California 9.0 followed by Fight for Your Right 7.7 and Magic Man 5.7.

In an exemplary embodiment, the chronology information could be used to vary the above determined weighting factors by reducing or increasing the weighting factors 375 based on whether a media file has been experienced within a certain time period, recently and/or frequency. Additional information regarding performing intelligent selection of media based upon user preference data and/or user exposure history data is provided in the instant inventor's co-pending U.S. patent application Ser. No. 11/285,534 and entitled “System, Method and Computer Program Product for Rejecting or Deferring the Playing Of A Media File Retrieved By An Automated Process,” filed Nov. 23, 2005 and Ser. No. 11/267,079 filed Nov. 3, 2005, and entitled “System, Method, and Computer Program Product for Automatically Selecting, Suggesting, and Playing Music Media Files,” which have been incorporated herein by reference.

In an exemplary embodiment, additional criteria may be incorporated into the media file selection process. For example, ambient factors may be used to further refine the media file selections. Information regarding inclusion of ambient factors is provided in the instant inventor's aforementioned co-pending U.S. patent application Ser. No. 11/267,079, filed Nov. 3, 2005.

Once the composite of the individual media taste preferences has been determined, one or more media files are retrieved from the datastore 235 using the composite data. The selected media file(s) 335 are operatively stored in the memory 10 and played by a media player program 300. The media player program 300 outputs the playing media file 335 to the audio processing subsystem. 80. The audio processing subsystem 80 then outputs the playing media file 335 in a human cognizable form to the loudspeakers 95A,B. In an exemplary embodiment, both audio and video outputs may be provided to the users (not shown.) For certain exemplary embodiments in which multiple media files are selected at once, they may be arranged in a playlist format that indicates which files are to be played as well as the order in which they are to be played. In common embodiments the media files are selected sequentially; a next media file being selected immediately before a previous media file completes play.

This arrangement enables close time proximity between the selection of a media file and the play of a media file, which is advantageous because it helps ensure that the plurality of users whose personal information is used by the groupwise media selection process is current at the time of selection. This helps account for new users who have joined the plurality (by coming within proximity of the media player) and/or old users who have left the plurality (by leaving proximity of the media player or by timing out), during the time period since the last media selection was made.

In certain exemplary embodiments, a media file is selected from a plurality of media files using a weighted randomization process that employs the media taste to preference data 330 and/or media exposure history data 340 of a plurality of users currently within listening proximity of the media player 100. The media taste preference data 330 for each of the plurality of users may be considered by the random selection process by the groupwise selection program 305. For example, if the media taste preference data 330 indicates that some or all of the plurality of users are favorable is toward a particular media file (i.e. have indicated that they like the particular media file, like the particular genre of media file to which it belongs, and/or like the particular artist associated with the media file) 325, that media file will be positively weighted within the random selection process such that it is statistically more likely to be selected than at random.

Alternately, if the media taste preference data 330 indicates that some or all of the plurality of users have indicates are not partial a particular media file (i.e. have indicated that they dislike the particular media file, dislike the particular genre of media file to which it belongs, and/or dislike the particular artist associated with the media file) that media file may be negatively weighted within the random selection process such that it is statistically less likely to be selected at random. In this way the random selection process is more likely to select media files that the members of the group of users are favorable. Partiality towards a particular media file, a particular genre of media file, a particular album or collection of media files, a particular time period of release of media files, and/or a particular media artist 325 may be represented within the media taste preference data 330 of each user in a plurality of ways.

In some exemplary embodiments, subjective rating data 345 may be stored within the media taste preference data 330, the subjective rating data 345 indicating a degree of partiality for particular media files, media genres, media albums, and/or media artists, on a scale for example from 0 to 10. For example, a 10 rating indicates that the user strongly likes the particular media file, media genre, media album, or media artist 325 to which the rating is associated, while a rating of 0 indicates that the user strongly dislikes the particular media file, media genre, media album, or media artist 325 to which the rating is associated. Rating between 0 and 10 thereby indicate the degree of partiality between the two extremes, rating values at or near 5 indicating a neutral partiality. Thus, in an exemplary embodiment, the media taste preference data 330 is stored within a personal information device 110 for each user, the media taste preference data 330 including values indicating the user's partiality toward particular media files, media genres, media albums or collections, and/or media artists 325.

The above described algorithms may be configured such that the random selection routines accesses the media taste preference data 330 from each of the plurality of users in the group of users and employs the media taste preference data 330 of each of the plurality of users in the determination of the weighting factor 375 determined for each of the plurality of media files 235. One skilled in the art will appreciate that there are a variety of methods by which the media taste preference data 330 for each of a plurality of users may be considered in the determination of the weighting factor 375 for each of a plurality of media files 235.

For example, an exclusive assessment algorithm may be employed by the groupwise selection program 305 such that the least preferred partiality to a particular media file 335 is stored for any single users and used by the algorithms described above. Thus, if any single user in the group strongly dislikes a particular media file, the algorithm lowers the weighting for the media file in the random selection process based upon the degree to which that user strongly dislikes the media file. Thus, in such an arrangement it is the user who most strongly dislikes a particular media file 335, that user's partiality governs the weighting of that media file 335 in the random selection process. Such an algorithm ensures that if any single user strongly dislikes a particular media file, the selection probability will be significantly reduced for the group of users by the weighted random selection routine.

In alternate exemplary embodiments, an averaging assessment algorithm may be used by the groupwise selection program 305 in the determination of the weighting factor 375 for each of a plurality of media files 235. In such an averaging assessment algorithm, the partiality data for a particular media file is accessed for each of the plurality of users in the group of users and is averaged together into a resultant composite value.

The resultant composite value is then used by the algorithms described above. Thus, if the algorithm considers the subjective rating partiality data 345 for a particular media file, the algorithm accesses media taste preference data 330 for each of the plurality users, averages the subjective rating data 345 for that media file 335 across the plurality of users, and employs averaged data in the weighting algorithm.

For example, if there were five users within the plurality of users, the groupwise selection program 305 will access media taste preference data 330 for each of the five users, including subjective rating values 345 for each of a plurality of media files 235 for each of the five users, and average the subjective rating values on a media file 335 by media file 335 basis across the five users.

Thus, for a particular media file 335 a composite subjective rating value 345 will be computed that is the average of the subjective ratings of that media file 335 for each of the five users in the plurality of users. This average value is then employed in the algorithms described above to determine the random selection weighting factor 375 for that particular media file. In this way, the central tendency of user partiality to a particular media file 335 among of the plurality of users in the group of five users will be considered by the algorithm.

If the central tendency (i.e. the average) indicates that the group as a whole is strongly favorable to a particular media file, the media file will be positively weighted in the random selection process. If the central tendency (i.e. the average) indicates that the group as a whole strongly dislikes the particular media item, the media items may be negatively weighted or reduced in significance in the random selection process. If the central tendency (i.e. the average) indicates that the group as a whole is neutral to the particular media item, the media items will be neutrally weighted in the random selection process.

It should be noted that other statistical methods, in addition to or instead of averaging, may be used to find the central tendency of partiality to a particular media file 335 among the group of users. For example, in some such exemplary embodiments, the median partiality value for a particular media file 335 may be found across a plurality of users. In other exemplary embodiments, more complex statistical assessments may be employed to determine the central tendency of partiality to a particular media file 335 among the plurality of users. The central tendency is then used in the weighted random selection process.

It should be noted while the above descriptions are provided with respect to the media taste preference data 330 for a particular media file 335; similar processes may be used for particular media genres, media albums, media collections, compositions and/or media artists 325. For example, in such implementations, if a user strongly dislikes a particular media genre, all media files associated with that genre 325 will be decreased in its weighting used by the random selection process. Similarly, if a user strongly likes a particular media artist, as indicated by the media taste preference data for that user, all media files associated with that artist will be increased in weighting used by the random selection process. In this way, multiple characteristics maybe considered simultaneously in the weighting of media files for random selection.

In some exemplary embodiments, a media file 335 is not merely negatively weighted or otherwise reduced in significance in the random selection process, but is removed altogether from consideration. This may occur if a media file 335 is universally disliked by one or more users in the group of users. This may occur if a media file 335 has been recently experienced by one or more users in the group of users. In some exemplary embodiments, the media file 335 is removed from a data structure that lists all media files available for selection at the current time. In other exemplary embodiments, the media file 335 is assigned a weighting value 375 of zero, which removes the media file from being selected.

In an exemplary embodiment, a weighted random selection process may be used in which the groupwise selection program 305 selects a media file 335 for play from a plurality of available media files 235 using a random selection method such that the probability of selecting a particular media file from the plurality of available media files is weighted 375 based upon the media exposure history data 340 and/or the media taste preference data 330 for each of the plurality of users.

For example, if the media exposure history data 340 indicates that some or all of the plurality of users have experienced a particular media file within a certain time period and/or a certain number of times within a certain prior time period 355, that particular media file is negatively weighted within the random selection process such that it is statistically less likely to be selected at random.

Alternately, if the media exposure history data 340 indicates that some or all of the users have not experienced a particular media file within a certain time period and/or have not experienced that particular media file more than a certain number of times within a certain previous time period, that media file is positively weighted 375 within the random selection process such that it is statistically more likely to be selected relative to a purely random selection process.

In this way, the groupwise selection program 305 provides a weighted random selection process such that media files 235 that have been recently experienced by some or all of the users are statistically less likely to be selected at random than media files 235 that have not been experienced recently by some or all of the users in the group of users.

The weighting process for a particular media file 335 may be configured to consider the elapsed time since the media file 335 was last experienced by each user in the group, assigning a more positive weighting to the media file 335 if the elapsed time is higher and assigning a less positive weighting (or a negative weighting) if the elapsed time is lower. In some such exemplary embodiments, a nominal threshold value may be assigned such that if the elapsed time is greater than the assigned threshold, a positive weighting is assigned with a value that increases positively with larger elapsed time, and if the elapsed time is lower than the assigned threshold, a negative weighting is assigned a value that increases negatively with smaller elapsed time.

If the threshold was assigned to be 24 hours, for example, a weighting algorithm could be implemented such that if a particular media file 335 has been experienced by a user in the group within the last 24 hours (as determined by the elapsed time associated with that media file 335 in the media exposure history data 340 of one or more users) the media file is negatively weighted or otherwise reduced in significance, the more recently the media file 335 had been experienced the more negatively weighted. And if a particular media file 335 has not been experienced by a user in the group within the last 24 hours (as determined by the elapsed time associated with that media file 335 in the media exposure history data 340 of one or more users) it is positively weighted, the longer ago the item had been experienced the more positively weighted. Such an algorithm may generally be constructed with a positive saturation point such that a media file 335 that has not been listened to by any of the user for more than some upper threshold amount of time is assigned a maximum positive weighting value enabled by the algorithm (for example is assigned 10 times the nominal chances of being selected at random).

Analogously, the algorithm may also be configured with a negative saturation point such that a media file 335 that has very recently been experienced by one or more of the users in the group of users, for example within the last ten minutes, may be assigned a maximum negative weighting (for example is assigned 1/10 the nominal chances of being selected at random) or is simply removed from the random selection process such that its chances of being selected are zero at the present time.

In addition to, or as an alternative to using the elapsed time that a particular media file 335 has been experienced, some weighting algorithms may be configured to consider the number of times (i.e., the frequency) for which a particular media file 335 was experienced within a particular prior time period. In such an weighting algorithm, the weighting process may be configured to positively weight a media file 335 more if it has been experienced a lower number of times over a given time period and negatively weight a media file 335 more if it has been experienced a greater number of times over a given time period.

The given time period may be an assigned value such as 10 days, for example. Thus the algorithm can be configured, for example, to positively weight a media file 335 more if it has been experienced a lower number of times during the past 10 days and negatively weight a media file 335 more if it has been experienced a greater number of times during the past 10 days. In some such exemplary embodiments, a frequency threshold value is assigned such that if the number of times a user has been exposed to the media file 335 during the defined time period is greater than the frequency threshold, a negative weighting is assigned with a value that increases negatively with increasing number of exposures. Similarly if the number of times that a user has been exposed to the media file 335 during the defined time period is less than the frequency threshold, a positive weighting is assigned with a value that increases positively with decreasing number of exposures.

If the frequency threshold was assigned to be 3 times, for example, a weighting algorithm could be configured such that if a particular media file 335 has been experienced by a user in the group more than 3 times within the last 10 days it is negatively weighted such that the more times it has been experienced, the more it is negatively weighted.

Alternately, or in addition thereto, if a particular media file 335 has been experienced less than 3 times within the last 10 days by any user in the group of users, it may be positively weighted such that the fewer times it has been experienced, the more it is positively weighted.

The above algorithms are such that the random selection routine accesses the media exposure history 340 from each of the plurality of users in the group of users and employs data from the media exposure history 340 of each of the plurality of users in the determination of a weighting factor 375 used for each of a plurality of media files 235.

There are a variety of methods by which the media exposure history data 340 for each of a plurality of users may be considered in the determination of the weighting factor 375 for each of a plurality of media files 235. In some exemplary embodiments, an exclusive assessment process is used such that the largest amount of exposure to a particular media file to any single user is incorporated into the algorithms described above.

Thus, if the algorithm considers the elapsed time since the last exposure to a particular media file 335, the algorithm collects media exposure history data 340 for each of the plurality users and employs the data from the users which indicates the shortest elapsed time for any of the plurality of users in the algorithm.

Thus, for example, if there were five users within the plurality of users, the media player 100 will access media exposure history data 340 for each of the five users and determine the elapsed time since each user was exposed to each of a plurality of media items. For each media file 235, the most recent exposure among any of the five users is employed in the algorithms described above to determine the random selection weighting factor 375 for that particular media file 335.

In this way if any users in the group of five users have been recently exposed to the media files 235, those media files 235 will be negatively weighted in the random selection process, the more recent the exposure the more negative the weighting.

In alternate exemplary embodiments, an averaging assessment algorithm may be used by the groupwise selection program 305 in the determination of the weighting factor 375 for each of a plurality of media files 235. In such an averaging assessment algorithm, the amount of exposure to a particular media file that is detected among the plurality of users in the group of users is averaged together and then employed by the algorithms described above.

Thus, if the averaging assessment algorithm considers the elapsed time since the last exposure to a particular media item, the algorithm accesses media exposure history data 340 for each of the plurality users, averages them together on a media file 335 by media file 335 basis across the plurality of users, and employs averaged data in the weighting algorithm.

For example, if there were five users within the plurality of users, the algorithms described above will access media exposure history data 340 for each of the five users, determine the elapsed time since exposure for each of a plurality of media files 235 for each of the five users, and average the elapsed times together on a media file 335 by media file 335 basis, across the five users.

Thus, for a particular media file 335 an average elapsed time since exposure value 355 will be computed that is the average of the elapsed times since exposure to that media file 335 for each of the five users in the plurality of users. This average value is then employed in the algorithms described above to determine the random selection weighting factor 375 for that particular media items. In this way, the central tendency of exposure to a particular media file 335 among of the plurality of users in the group of five users will be considered by the algorithm. If the central tendency (i.e. the average) indicates that the group as a whole has been exposed recently to the particular media file 335, the media file 335 will be negatively weighted in the random selection process, the more recent the exposure the more negative the weighting.

It should be noted that other statistical methods, in addition to or as an alternative to averaging, may be used to find the central tendency of exposure to a particular media file 335 among the group of users. For example, in some such exemplary embodiments, the median elapsed time 355 since exposure may be used.

In exemplary embodiments, more complex statistical assessments may be employed to determine the central tendency of exposure to a particular media file 335 among the plurality of users. The central tendency is then used in the weighted random selection processes described previously.

FIG. 4 depicts a flow chart of an exemplary embodiment which performs the various functions and processes of the groupwise selection program. The process is initiated 400 by is establishing processing communications with one or more personal information devices 405. The personal information devices include RFID chips, smartcard chips, cellular telephones, portable media players, PDAs, portable computing devices, and a third party server 410. In an exemplary embodiment, the personal information devices establish processing communications with a third party server 415 over a wireless communications link 415. In this exemplary embodiment, the third party server receives proximity data from the personal information devices 420 and determines whether one or more of the portable information devices is within a predetermined proximity or area near a media player 425. If none of the portable information devices are within a predetermined proximity of the media player 425, the third party server continues monitoring the GPS data 420 until one or more of the portable information devices enter the predetermined proximity of the media player.

In another exemplary embodiment, the personal information devices establish processing communications with a third party server 415 over a wireless communications link 415. In an exemplary embodiment, the third party server receives messaging data 418 from the personal information devices indicating that the user is within listening proximity of a particular media player and wishes to have personal information included in a groupwise media selection process for that media player. The messaging data generally includes a unique ID for the user, enabling the accessing of personal information for that user indexed by the unique ID 418. The messaging data may also include unique ID for the particular media player (or physical location of play of the media player); enabling the personal information for that user to be used in a groupwise media selection process associated with that particular media player (or associated location).

In some exemplary embodiments, the messaging data received by the third party server is an SMS message sent by a personal information device in response to user interaction 418. In this way a user may send an SMS message to the third party server indicating a desire to have his or her media taste data and/or media history data used in the groupwise media selection process for a particular media player. In one such embodiment the user of the personal information device sends a text message to the third party server that includes a unique ID code for the particular media player (or associated location) that he or she wishes to have his or her media taste data and/or media history data used in the groupwise media selection process.

In one such exemplary embodiment, the unique ID code for the particular media player (or associated location) is encoded as unique numeric value bracketed between two pound symbols, for example #162342#. This allows the SMS message or other electronic message sent to the third party server to be easily parsed by routines of the third party server such that any numeric value that is received between two pound signs is interpreted to be the unique ID code of a particular media player (or associated location) to which the request applies.

While a variety of symbols could be used for identifying the numeric code of a particular media player (or associated location), the pound signs are particular convenient for users of mobile phones because they may be entered on a standard telephone keypad without needing to engage a shift function or other multi-step process. In this way a user may send an SMS message or other similar electronic message from a mobile phone to the third party server that consists only of the string #563482# and cause the routines of the present invention to include the media taste data and/or media history data for that user in the groupwise media selection process for the media player associated with the unique code 563482. In such an exemplary embodiment, the unique identity of user may be determined from the phone number or other electronic address of the mobile device from which the message was sent. This arrangement enables a very short and simple text message to trigger the inclusion of a particular user's media taste data in the groupwise media selection being performed for a particular physical location.

In another exemplary embodiment, the media player interrogates 430 the portable information devices 430 within the predetermined proximity or area. The portable information devices send data representations of user media taste preferences to the media player 435. The media player determines a composite of the user media taste preference data 440 for preferentially selecting one or more media files which are likely to be favored by a majority or a significant portion of users associated with the portable information devices.

In an exemplary embodiment, weighting factors are applied to the determining process 445. The groupwise selection program performs a comparison of the composite of the user media taste preference data to one or more predetermined characteristics associated with the media files stored in a datastore 450.

The groupwise selection program then selects one or more media files in dependence on the composite of the media taste preferences 455. The composite of the media taste preferences is generated from one or more characteristics of a genre, artist, album or composition 460 taste preferences. In an exemplary embodiment, a level of correspondence is determined between the composite of the user media taste preference data 440 and the one or more characteristics 458.

In an exemplary embodiment, the composite of the media taste preferences is generated from chronological media exposure history, number of times played and/or playing periodicity 465. In an exemplary embodiment, the composite of the media taste preferences is generated using rating factors provided by the individual users in response to experiencing a media file 470. In still another exemplary embodiment, ambient factors may be incorporated into the composite of the media taste preferences 475.

In an exemplary embodiment, a weighted random selection process is provided which utilizes the previously determined weighting factors 445. In an exemplary embodiment, a playlist referencing a plurality of media files maintained in the datastore is generated for play by the media player 485. The selected media file(s) are then played to the users in proximity to the media player 490. The process ends when all media files have been played 495.

The foregoing described exemplary inventive embodiments are provided as illustrations and descriptions. They are not intended to limit the inventive embodiments to any precise form described in particular, it is contemplated that functional implementation of the various inventive embodiments described herein may be implemented equivalently in hardware, software, firmware, and/or other available functional components or building blocks and performed in any order or sequence.

What is claimed:

1. An intelligent groupwise media selection system comprising: a plurality of personal information devices, each personal information device being associated with an individual user and having retrievably stored therein a data file representing the individual user's media taste preferences; a media player including; a processor; a communications transceiver operatively coupled to the processor and in processing communications with each of the plurality of personal information devices; a memory coupled to the processor; a plurality of media files retrievably stored in the memory; a groupwise selection program operatively loaded into the memory having instructions executable by the processor to; interrogate the personal information devices to receive a representation of the data files; determine a composite of the media taste preferences of the individual users from the received data file representations, select a media file from the plurality of media files in dependence on the determined composite media taste preferences; and, play the selected media file to at least a portion of the individual users.

2. The system according to claim 1 wherein the media file is selected in dependence on an assessed level of correspondence between at least a portion of the composite media taste preferences and a characteristic associated with the selected media file.

3. The system according to claim 1 wherein the groupwise selection program further comprises instructions executable by the processor to select a plurality of media files in dependence on the composite media taste preferences of the individual users and arrange the plurality of selected media files in a playlist for play.

4. The system according to claim 1 wherein the data representing the media taste preferences further comprises a user rating with respect to a musical characteristic.

5. The system according to claim 4 wherein the musical characteristic consists essentially of a musical genre, a musical artist, a musical album, a musical composition and any combination thereof.

6. The system according to claim 1 wherein the media taste preference data files further comprise data representing media exposure history; the media exposure history data including event data associated with a number of times an individual user experiences a particular media file over a period of time.

7. The system according to claim 2 wherein the groupwise selection program further comprises instructions executable by the processor to calculate and apply a weighting factor associated with the selected media file in dependence on the assessed level of correspondence.

8. The system according to claim 7 wherein the groupwise selection program selects the media file from among the plurality of media files using a weighted random selection process that applies the weighting factor.

9. The system according to claim 1 wherein the personal information device is selected from the group consisting essentially of an RFD chip, a smartcard chip, a cellular telephone, a portable media player, a personal digital assistant and a third party server.

10. The system according to claim 1 wherein at least one of the personal information devices further comprises a global positioning system receiver for determining a current geospatial location of the user of that personal information device, the current geospatial location being used to determine if that user is within certain proximity of the media player.

11. The system according to claim 10 wherein data representing the geospatial location of at least one personal information device is transmitted to a third party server for determination of whether the data representing the media taste preferences of the user is to be conveyed to the media player by the third party server.

12. The system according to claim 1 wherein data representing a unique ID associated with a particular user is transmitted to a third party server that accesses media taste preference data for that user and provides a representation of the media taste preference data to the media player for a groupwise media selection process.

13. A computer implemented method for performing intelligent groupwise media selection comprising: establishing processing communications with a plurality of personal information devices in proximity to a media player, each personal information device being associated with an individual user and having retrievably stored therein a data file representing each user's media taste preferences; receiving from each personal information device a representation of the user's media taste preferences; determining a composite of the media taste preferences of the individual users from the received data tile representations; selecting a media tile from the plurality of media files in dependence on the determined composite media taste preferences; and, playing the selected media file to at least a portion of the individual users.

14. The computer implemented method according to claim 13 wherein the media file is selected in dependence on an assessed level of correspondence between a least a portion of the composite media taste preferences and a characteristic associated with the selected media file.

15. The computer implemented method according to claim 13 further comprising selecting a plurality of media files in dependence on the composite media taste preferences of the individual users and a ranging the plurality of selected media files in a playlist for play.

16. The computer implemented method according to claim 13 wherein the data files further comprise media exposure history data; the media exposure history data including numerical data related to the number of times each individual user experiences a particular media file over a period of time.

17. The computer implemented method according to claim 13 wherein at least one of the personal information devices further comprises a global positioning system receiver for determining a current geospatial location of the user of that personal information device, the current geospatial location being used to determine if the user is within certain proximity of the media player.

18. The computer implemented method according to claim 13 further comprising; sending data representing each user's location to a third party server; determining whether the data representing the media taste preferences of each user is to be conveyed to the media player by the third party server in dependence on each user's location; and conveying the data representing each user's media taste preferences to the media player if it is determined that one or more of the users is within a predetermined area or in a predetermined proximity to the media player.

19. A computer implemented method for performing intelligent groupwise media selection comprising: receiving media taste data for each of a plurality of individual users in listening proximity to a media player of a physical establishment, the media taste data indicating each user's level of preference towards at least one of a particular musical artist, a particular musical album, a particular musical genre, and a particular musical composition; selecting at least one musical media file from a plurality of musical media files in dependence at least in part on the media taste data received from each of the plurality of individual users; and, causing the at least one musical media file selected to be played by the media player.

20. The computer implemented method of claim 19 wherein the media taste data associated with each individual user is received over a wireless communication connection from a personal information device associated with each user.
